(19) United States
(12) Patent Application Publication
(10) Pub. No.: US 2017/0069035 A1
(43) Pub. Date: Mar. 9, 2017

(54) SYSTEMS AND METHODS FOR MATCHING CONSUMER REQUESTS WITH INSURANCE UNDERWRITER APPETITES

(71) Applicants: Marilyn C. Quinlan, San Francisco (CA); Marcia H. Kawabata, San Bruno (CA); Brendan P. Quinlan, San Francisco (CA)

(72) Inventors: Marilyn C. Quinlan, San Francisco (CA); Marcia H. Kawabata, San Bruno (CA); Brendan P. Quinlan, San Francisco (CA)

(21) Appl. No.: 15/356,609

(22) Filed: Nov. 20, 2016

Related U.S. Application Data
(63) Continuation-in-part of application No. 12/718,784, filed on Mar. 5, 2010, now abandoned.
(60) Provisional application No. 61/158,249, filed on Mar. 6, 2009.

(51) Int. Cl. G06Q 40/08; G06Q 30/02

(52) U.S. Cl. CPC G06Q 40/08; G06Q 30/0282

(57) ABSTRACT

Provided are electronic systems and methods to help intermediary members to bring together consumers and insurance underwriter members, wherein the consumers, insurance underwriter members and intermediary members may have different systemic rights. The inventive systems and methods employ a dynamic compilation of electronic entries that is updatable at the pleasure of insurance underwriter members so that the entries set forth substantially current insurance underwriter appetites anytime. Electronic queries containing consumer requests, e.g., submitted by intermediary members, are matched with appropriate appetites. Once such matching has occurred, the identifier for appropriate insurance underwriters, e.g., property and casualty insurance underwriters, are displayed.

### CROSS REFERENCE TO RELATED APPLICATIONS

This application is a continuation-in-part of U.S. patent application Ser. No. 12/718,784, entitled “SYSTEMS AND METHODS FOR MATCHING CONSUMER REQUESTS WITH SUPPLIER APPETITES,” filed on Mar. 5, 2010, by inventors Quinlan, Kawabata, and Quinlan, which claims priority to U.S. Provisional Application Ser. No. 61/158,249, entitled “SYSTEMS AND METHODS FOR MATCHING CONSUMER REQUESTS WITH SUPPLIER APPETITES,” filed on Mar. 6, 2009, by inventors Quinlan, Kawabata, and Quinlan, the disclosures of which are incorporated by reference in their entireties.

### BACKGROUND

Field of the Invention

The invention relates generally to systems and methods that match consumer requests with appetites of suppliers. More specifically, the invention relates to electronic systems and methods that match consumer requests, typically submitted by members of an intermediary membership, with substantially current appetites of members of a supplier membership to provide products that may satisfy the consumer requests.

Description of Background Art

In economic theory, an intermediary is generally defined as an entity that offers intermediation services between trading parties. For example, an intermediary may act as a conduit for goods offered by a supplier to a consumer. Traditionally, intermediaries are viewed as entities who add value to transactions that may not be possible via direct trading between the trading parties.

Numerous industries employ intermediaries. For example, in the financial services industry, financial advisers may offer intermediation services to supply financial products such as mortgage and investments products. Similarly, in the insurance industry, insurance brokers often bring consumers and insurance carriers together so that a contract, e.g., an insurance policy, may be formed therebetween.

During the internet boom of the 1990s, suppliers and consumers alike welcomed the availability of an ever-increasing wealth of commercial information via the internet. In addition, suppliers recognized that the internet may allow them to automate many of the functions traditionally carried out by intermediaries. Conventional wisdom at that time was that the internet may allow a supplier to reduce the cost of servicing customers directly. As a result, disintermediation or “cutting out the middleman” gained acceptance as the dominant economic paradigm in web-based transactions.

Suppliers for numerous industries sought to exploit the internet as a means to deal with customers directly, instead of going through traditional distribution channels, which had some type of intermediary. Internet-based technologies designed for commercial transactions were generally set up to facilitate direct supplier and consumer communication, leaving no room for intermediaries. Such disintermediation efforts had a strong impact on entities such as travel agencies, ticketing entities, stock brokerages, bookstores, music stores, retailers of computer hardware and software, and other intermediaries of goods.

Since then, it has been observed that internet-related disintermediation has occurred less frequently than many had predicted. It turns out that many intermediaries provide essential functions for commercial transactions that had been overlooked or unduly discounted. For example, suppliers did not consider that they had to spend huge resources to address any pre- and post-sales issues of individual consumers previously provided by intermediaries. In addition, consumers had, before disintermediation, often viewed middlemen, particularly those that are licensed by governmental entities, as trusted sources of expert information. With the elimination of middlemen, suppliers often lacked the resources and/or expertise to address consumer concerns. Furthermore, suppliers did not consider that selling online also has high costs, e.g., developing the web site, maintaining the information and marketing expenses to draw online consumers.

In any case, with the growth of the internet came an abundance of information. Most information on the internet is found today using online search engines, e.g., found at google.com, yahoo.com or live.com, that employ indices formed by “web crawlers.” The web crawlers form the indices to parse pages on the web, the pages to which those pages link, and so on. The indices used by search engines are typically based on words found on those pages, as well as position, prominence, frequency of user access, and other attributes. Results are typically returned in a linear list of items, based on some form of ranking.

The automated approach, however, has its drawbacks. For example, false positive results often occur when a consumer lacks the knowledge or expertise regarding the industrial terms of art necessary to carry out an effective search. In addition, given the number of websites in operation today, it is not uncommon for desired results to be “buried” due to its low ranking.

Furthermore, the abundance of web-based information includes both good and bad information. For example, anyone with access to the internet can create web sites about topics that interest him or her. These sites may be neither accurate nor timely, and may serve to confuse or misdirect rather than to educate the consumer.

Thus, intermediaries continue to serve an important and desirable function in certain types of commercial transactions. For example, intermediaries may have specialized knowledge to help consumers seeking to purchase a specialized good that they would purchase only infrequently. Because the good is not one that is ordinarily purchased by the consumer, the consumer's lack of experience may result in the consumer wasting an inordinate amount of time trying to go at it alone without expert guidance.

The commercial property and casualty insurance industry is one in which many consumers rely on the expertise of intermediaries to find insurance carriers potentially willing to fulfill their insurance needs. Such intermediaries include brokers who are licensed by appropriate licensing entities, e.g., state governments, and have special knowledge of the insurance industry beyond that of the ordinary consumer. In essence, insurance brokers are hired by consumers to help the consumers determine what type of insurance coverage the consumers need, and to contact carriers to see whether they are willing to offer such coverage.

Due to the complexity of the insurance industry, even experienced brokers may sometimes have trouble matching consumer requests with carrier appetites. In general, insurance carriers have an appetite for (are receptive to) insurance requests for only certain types of “risks.” In addition, such appetites for risk are typically quite dynamic due to various factors such as their carriers' loss experiences or changing legal environment in a given jurisdiction in which the carriers operate. Furthermore, there are currently over two-thousand six-hundred insurance carriers in the United States, and there is no convenient or systematic way for brokers to know to what type of request each carrier is receptive to at any particular time.

To serve the consumer, the broker may have to navigate the web to access each of the carrier's websites that may be of interest and figure out where in each website the needed information may be found. There are no standards or protocols for the websites; each website may be set up differently. Appetites can be described in different ways, e.g., listed by carrier-specific departments, by type of insurance, type of business, or any other attribute.

Furthermore, methods used by brokers for matching consumers and insurance carriers have remained essentially unchanged for decades. For example, carriers may hire representatives to contact brokers and to remind them of the carriers' appetites. Such efforts are generally ineffective because brokers typically do not have time to see all carriers' representatives. In addition, brokers who get marketing material from representatives or by e-mail or mail correspondence, generally ignore them. In some instances, the carriers do not even know whether the correspondence is directed to appropriate individuals.

As a result, a number of problems arise for insurance carriers. For example, insurance carriers tend to receive a high number of unwanted insurance requests and spend the bulk of their time reviewing requests they will not insure, thereby leading to wasted time and resources. In fact, a large insurance carrier may decline as much as 80% of the requests they receive as the requests do not fit their appetites. In addition, carriers may not receive requests for insurance they would like an opportunity to provide because the brokers are unaware of the carriers' desire to insure a certain type of risk, thereby leading to missed opportunity and revenue.

Similarly, brokers experience problems as well. Brokers tend to spend a lot of time looking for insurance companies that may be able to meet client consumer needs. In addition, insurance brokers may never know of all the insurance companies who can offer the insurance their client needs. As a result, brokers often end up using only carriers with which they have a high level of familiarity. In such cases, clients of the brokers may not be presented with optimum insurance solutions because brokers overlook carriers who may have a better product for their clients. Even worse, brokers may lose business to a competitor because they are blindsided by a known carrier whose appetite has recently changed.

Although there have been some attempts in the past to create electronic directories to overcome the above described problems, they proved unworkable. The attempts failed because they were generally static, complex, limited to a few carriers, and not controlled by the carriers who own their appetite. At best, past attempts merely involved static electronic directories with no search capabilities. As soon as they are published, they can be obsolete.

Electronic technologies known in the insurance industry have not addressed the problem of matching consumer request with carrier appetites. For example, U.S. Patent Application Publication No. 2005/0187799 to McGriffin et al. describes web-based systems for managing an underwriting account of an insurance policy. In addition, U.S. Patent Application Publication No. 2005/0187881 to McGriffin describes computer-readable memory having stored thereon a data structure that is based on a relational data model. Both of these patent applications assume that carriers have already been matched with consumers.

Thus, opportunities exist to overcome the drawbacks as discussed above and to facilitate commercial transactions that may employ an intermediary to assist in matching the appetites of suppliers with the needs of consumers.

### SUMMARY OF THE INVENTION

In a first embodiment, the invention provides electronic, e.g., web-based, systems that include a dynamic compilation of electronic entries, an electronic entry-updating means, an electronic query means, an electronic filtering means, and a display means. Each entry of the compilation is identified by a unique identifier which may be updatable at will via the electronic entry-updating means. The electronic query means allows for the input of a request as a query. The electronic filtering means serves to determine whether any entry from the compilation matches the query. The display means displays at least the unique identifier of any matching entry by the electronic filtering means. Optionally, the systems may include a membership rights means that provide different systemic rights for member of different membership categories.

Typically, such systems may be provided to assist members of an intermediary membership to match a consumer request with substantially current appetites of members of an insurance underwriting membership to provide products that may satisfy the consumer request. Such products may include, for example, insurance and other products that an underwriter may provide. In some instances, the products may be of an informational nature, e.g., supply contact information. Furthermore, the products may exclude products that involve health insurance or other products of a nature that is better suited for suppliers and consumers to contact each other directly, e.g., without a broker. In addition or in the alternative, either or both of the intermediary and supplier members may be registered with and/or licensed by a governmental licensing entity.

Also typically, each current appetite includes at least one subappetite. Each subappetite may be at least partially classifiable by a first attribute selected from a first class of attributes and by a second attribute selected from a second class of attributes. Optionally, each subappetite may be classifiable by one or more additional attributes selected from additional classes of attributes, e.g., a third class of attributes. The different classes of attributes may share no common attribute with each other. In any case, the electronic query means may accept queries that comprise a plurality of subqueries. In turn, the electronic filtering means may select matching entries from the compilation by matching attributes with subqueries.

In another embodiment, methods are provided to match consumer requests with substantially current appetites of members of a supplier membership. The method involves accepting input of a consumer request as a query and using the query to determine whether any entry from a compilation of electronic entries as described above is a matching entry. Then, at least the unique identifier of any matching entry is displayed.

In a further embodiment, methods are provided that involve inputting a consumer request as a query used to determine whether any entry from a compilation of electronic entries as described above is a matching entry. Then, information comprising at least the unique identifier of any matching entry is retrieved. Optionally, the retrieved information is communicated to the customer.

Other embodiments of the invention will be apparent to those of ordinary skill in the art in view of the disclosure contained herein.

### BRIEF DESCRIPTION OF THE DRAWINGS

FIG. 1 is a flow chart that describes an embodiment of the invention that allows insurance brokers to match consumer requests with appetites of insurance carriers as defined by three different attributes, i.e., line of coverage, Standard Industry Classification (SIC) code, and primary state of the consumer's location and where insurance coverage is offered by the insurance carriers.

### DETAILED DESCRIPTION OF THE INVENTION

### Definitions and Overview

Before describing the invention in detail, it is to be understood that the invention is not generally limited to specific electronic formats or types of platforms, as such may vary. It is also to be understood that the terminology used herein is intended to describe particular embodiments only, and is not intended to be limiting.

Furthermore, as used in this specification and the appended claims, the singular article forms “a,” “an,” and “the” include both singular and plural referents unless the context clearly dictates otherwise. Thus, for example, reference to “an entry” includes a plurality of entries as well as a single entry, reference to “a query” includes a single query as well as a collection of queries, and the like.

In this specification and in the claims that follow, reference is made to a number of terms that are defined to have the following meanings, unless the context in which they are employed clearly indicates otherwise:

The term “appetite” as used here generally refers to a desire of an entity to satisfy its craving to conduct a particular type of transaction, e.g., sales of a particular type of goods. For example, a “supplier's appetite” may refer to the receptivity of a supplier to entertain inquiries as to whether the supplier desire to sell goods of particularized attributes. As a related matter, a supplier who may wish to sell different goods each having its own particularized attributes may be said to have an appetite comprising a “subappetite” for each of the different goods. In any case, the term “appetite” and its usage in the context of the invention are described in detail below.

The term “attribute” as in an “attribute of an item” is used in its ordinary sense and may refer to, for example, a quality or characteristic inherent in or ascribed to the item. Thus, an attribute of a particular appetite may serve to distinguish the particular appetite from other appetites that may not have the attribute.

The term “broker” is used herein in its ordinary sense and may, for example, refer to an entity who buys goods for a consumer on a commission or fee basis without holding title to the goods, or an entity that functions as an intermediary between trading parties in negotiating agreements, bargains, or the like.

The term “compilation” refers to a work formed by the collection and assembling of materials or of data that are selected, coordinated, or arranged in such a way that the resulting work as a whole constitutes an original work. The term “compilation” includes “collective work,” which refers to a work in which a number of contributions, constituting separate and independent works in themselves, are assembled into a collective whole.

The term “consumer” is used herein in its ordinary sense and refers to an entity that consumes, especially one that acquires goods for direct use or ownership rather than for resale or use in production and manufacturing.

The terms “electronic,” “electronically,” and the like are used in their ordinary sense and relate to structures, e.g., semiconductor microstructures, that provide controlled conduction of electrons or other charge carriers. For example, the term “electronic entry” may refer to an entry, the production, form, and/or transmission of which involve controlled conduction of electrons in a digital and/or analog manner.

The term “entry” is used herein generally in its ordinary sense and refers to the inclusion or insertion of an item, as in a record or a work that forms a portion of a compilation. Unless the context of usage clearly indicates to the contrary, the term “entry” also includes “revision,” e.g., an improved or up-to-date entry.

The term “good” is used herein in its ordinary sense may refer to products and services that have value and/or use that may generally be obtained by consumers via purchase and/or barter.

The term “internet” is used herein in its ordinary sense and refers to an interconnected system of networks that connect computers around the world via the TCP/IP and/or other protocols. Unless the context of its usage clearly indicates otherwise, the term “web” is generally used in a synonymous manner with the term “internet.”

The term “member” as in a “member of a membership” is used in it ordinary sense and generally refers to a distinct part of a whole such as one that belongs to a group or a membership organization.

The term “substantially instantaneous” is used to refer to one or more events that to a considerable degree occur or are completed with no delay, but that the absolute absence of any delay is not required. For example, when a web-based entry is updatable by its supplier member in a “substantially instantaneous manner,” the entry must under ordinary circumstances reflect changes entered by the supplier member within a few seconds of the entry of the changes. The terms “substantial” and “substantially” are used analogously in other contexts involving an analogous definition.

The term “underwriter” is used in its ordinary sense and may, for example, refer to an entity that assumes liability in case of specified losses, insures against losses totaling a given amount or guarantees the purchase of a full issue of stocks or bonds. The term “insurance underwriter” may be synonymously used with the terms “insurance carrier” and “insurance company.”

In general, the invention provides systems and method for bringing together consumers and suppliers, typically via efforts of an expert intermediary such as an insurance broker. The inventive systems and methods employ a dynamic compilation of electronic entries that is updatable at the pleasure of suppliers so that the entries set forth substantially reflect current supplier appetites at anytime. Electronic queries containing consumer requests are matched with appropriate appetites. Once such matching has occurred, the identifier for appropriate suppliers are displayed, thereby allowing for more follow up communication to take place between the consumer and the supplier, optionally through the expert intermediary.

Typically, the invention offers different systemic rights to different type of entities. For example, when the inventive system is constructed to assist intermediary members to match a consumer request with substantially current appetites of supplier members, the intermediary members, supplier members, and consumers may be restricted from accessing different components of the system. In such a case, entities having only intermediary membership rights or only consumer rights may not be able to revise any electronic entries while entities having only supplier membership rights or consumer rights may not be able to access the system's search functionality. In any case, eligibility requirements for different membership rights may depend on legal issues. For example, supplier or intermediary membership rights may require registration with and/or licensing by a governmental licensing entity.

The invention is particularly useful in the context of property and casualty insurance companies. In the past, insurance brokers such as those who find business insurance for clients (consumers) and insurance carriers utilize highly inefficient processes to find each other. Such processes are generally manual in nature and do not allow for quick, efficient, real time communication of a carrier's current appetite, or change in appetite for risk. In contrast, the invention provides an online searchable, dynamic database comprised of many insurance carriers that allows the brokers to find suitable matches for their clients. As insurance carriers' appetites change or as the carriers decide to enter or leave certain markets, the carriers can make changes immediately to the database. Such changes may alert brokers searching the database the carriers' receptivity (or hostility) to broker attempts to establish contact on behalf of consumers.

### Entries, Attributes Thereof, and Updates Thereto

As discussed above, the invention pertains to electronic systems that include a compilation that includes a plurality of electronic entries that set forth substantially current appetites of supplier members to provide goods that may satisfy consumer demands. The compilation may be fixed in any of a number of tangible medium of expression. For example, the compilation, for example, may be stored in microelectronic devices, magnetic disk drives, and/or optical disks and accessed electronically.

Any of a number of different industries may benefit from the invention, though the entries of the invention typically form a compilation that contains information relating goods of the same industry. For example, the electronic entries may set forth appetites to supply intangible goods such as insurance products, informational products, financial products, or software products. In some instances, the goods may have renewal periods. In addition or in the alternative, the entries may set forth appetites to supply tangible goods.

The invention is also particularly suited for use in government-regulated industries the goods of which are generally complex in nature and are not easily distinguishable from each other by ordinary consumers. For example, the invention may provide a database of information relating to the goods of an industry subject to governmental regulations enacted with the legislative intent to provide consumer protection due to the goods' complexity. Such governmental regulations may be enacted at the state level and/or at the national level. For example, state laws and regulations have been enacted to govern the insurance industry to prevent collusive and anticompetitive behavior. Similarly, numerous laws and regulations have been enacted to govern banking and the securities industries.

While the entries and appetites of the invention may vary in format, it is preferable that the entries be generally uniform in format. For example, the entries should be formatted so that they each have a unique identifier for its supplier member. In some instances, the unique identifier includes contact information for its supplier member.

In addition, the entries should be organized in some manner. For example, each appetite may be comprised of a single subappetite or a plurality of subappetites of generally similar formats. To facilitate organization and searchability, each subappetite may be classifiable at least in part by two or more different classes of attributes. The attributes classes may share no attribute in common. While subappetites for the same appetite may exhibit certain common attributes, each subappetite should exhibit a unique combination of attributes.

In some instances, each appetite may be classifiable by three or more attributes selected from different classes of attributes. In such systems at least two classes of attributes may share no common attribute. Preferably, no class of attributes may share any common attribute. The attributes are typically independently selectable. Furthermore, each subappetite may be classifiable by a desirability rating.

Depending on the particular industries involved, the appetites and subappetites of the invention may be classifiable through different classes of attributes. For example, the entries may set forth an appetite of a supplier to do business in different geographic regions. For such suppliers, their entries may be classifiable by a geographic attribute consisting essentially of states or postal service codes. For insurances carrier appetites, additional important attributes include industry class, such as Standard Industry Classification (SIC) codes, North American Industry Classification System (NAICS) codes, codes particular to nonprofit organizations e.g., nonprofit designation codes used by the United States Internal Revenue Service, etc., and insurance descriptor class.

An electronic entry-updating means is also provided to allow supplier members to update their entries at will. This may be done in different ways. For example, any existing entry containing an appetite that no longer reflects the current desires of the entry's supplier may be replaced by a revision that differs at least somewhat from the entry. However, the extent or degree to which the existing and revision differ may vary. For example, previous entries and the current revision for any supplier may set forth appetites having different numbers of subappetites. In addition or in the alternative, appetites may be changed by adding and/or deleting one or more different subappetites. Such changes may be reflected by the compilation and be accessible for searching in a substantially instantaneous manner.

In effect, then, the appetite contained in each entry is owned by its corresponding supplier member. No entry may be revised or updated by any entity other than its owner without owner consent. Passwords, biometrics, and other known security technologies may provide selective editing access to the entries.

While the invention requires a compilation of more than one electronic entry, there is no hard limit as to the number of entries needed for the practice of the invention. Typically, the compilation should contain as many entries that may be needed to provide a fairly comprehensive database for the relevant industry. That way, the invention may serve to create an efficient market and a single source for intermediaries for a particular industry to identify the appetite of at least a substantial portion of all suppliers for the industry.

### Intermediary Queries and Entry Searching

From the information contained in above-described compilation, intermediary may readily search for suppliers having appetites that may satisfy consumers who are clients of the intermediary. Thus, an electronic query may be provided to allow intermediary members to input consumer requests. This allows an electronic filtering means to determine whether any entry matches the consumer request. A display means may serve to display to the intermediary member at least the unique identifier of any matching entries. In turn, the intermediary may initiate contact with the appropriate suppliers on their clients' behalf.

Various known electronic query means may be adapted for used in conjunction with the invention. For example, U.S. Pat. No. 5,978,798 to Pozbabski et al. describes methods for accessing databases that comprise a plurality of entries involving headwords. In addition, search engine technologies may be adapted to analyze the contents of each entry to determine how it should be indexed relative to a query.

When the entries of the invention are organized, the organizational structure may be used to determine whether any supplier's appetite matches the consumers' requests. For example, when the appetites are comprised of subappetites that are classified by different classes of attributes, the query means may require a searcher to enter one, two, three, or more subqueries that describe the consumers' request. Matching entries may be then selected according to predetermined selection attribute. For example, a matching subappetite may have one, two three, or more attributes that match the one, two, three, or more subqueries, respectively.

Once a match is found, a display means may be employed to display a unique identifier for any matching entry. Exemplary display means include computer monitors, printers, portable media players, cellular phones, etc. When a plurality matching entries are found, their unique identifier may be displayed in any desirable order. For example, the identifiers may be ordered alphabetically, by distance to the searcher, or by how well the matching entries match the queries, etc. Optionally, when a plurality of matching entries are found and each matching entry has a subappetite is classified by a desirability rating, the unique identifiers of the matching entries may be presented in an order that is determined at least partially according to the desirability ratings of the subappetites of the matching entries.

### Membership Rights

As alluded to above, the invention typically involves entities of three distinct categories—a supplier membership, an intermediary membership, and consumers. In some cases, an entity may be members of multiple memberships. For example, a consumer may also be a member of either, but not both, intermediary and supplier memberships.

Typically, the systemic rights for members of different memberships differ, and a membership rights means, e.g., software and/or hardware, may be employed to ensure that users are accorded systemic rights appropriate to their membership. For example, supplier members and consumers may be prohibited from accessing the electronic query means and accessing any entry for other members. Similarly, intermediary members may be prohibited from accessing the electronic-updating means. In some instances, intermediary members and consumers may be provided read-only access to the entries. When an entity is a member of multiple memberships, conflicting systemic rights for the different memberships may be resolved either in favor or against access.

Furthermore, eligibility requirements may differ for the different categories of membership. For example, in the insurance industry, supplier members and intermediary members may be required to be registered with and/or licensed by a governmental licensing entity, e.g., the commissioner of insurance for any of the fifty states. In addition, or in the alternative, the governmental licensing entity may be a national governmental entity.

Depending on the nature of the invention, various entities may be accorded membership rights. For example, membership rights may be provided to humans, associations, foundations, trusts, corporations, partnerships, limited partnerships and/or combinations thereof. Typically, registration is required for membership. In addition, eligibility requirements for different memberships may vary according to the nature of the invention. For example, membership eligibility may involve educational and/or other qualifications such as professional licenses that have jurisdictional limitations. Testing/examinations may also serve to be a basis for membership eligibility. For example, when membership eligibility is limited to humans, a test may be given to ensure that a potential member has at least human-like skills. This may involve, for example, requiring a potential member to retype wavy or some other human-recognizable-but-machine-confusing alphanumeric text into an entry box so as to prevent access by automated programs. So called “CAPTCHA” (Completely Automated Public Turing test to tell Computers and Humans Apart) technologies may be used.

In instances where verifiable identification is required, various technologies known in the art may be used. For example, credit cards, phone numbers, social security numbers, national identity codes, license numbers, registration data, email address and other information may be used to verify the identify of any person or entity associated with the invention. Optionally, crytographic schemes and methods, e.g., PGP (pretty good protection) encryption techniques involving large prime numbers, may be used as well to verify the identity of the person or entity while providing a certain degree of privacy. Legally enforceable protections schemes may be provided as well.

### Exemplary Embodiment

As alluded to above, an appetite, in insurance industry parlance, sets forth the kind of business an insurance carrier wants. Each insurance carrier has a unique, specific and defined appetite. A carrier's unique appetite is based on its own loss experience and underwriting expertise.

Also as alluded to above, such appetites are dynamic in nature because they may change over time. For example, when insurance underwriters experience claims against policies in a given geographic market or by type of business they may want to stop underwriting similar policies immediately. Conversely, underwriters may want to enter new markets immediately.

Currently, there is neither an efficient way for insurance underwriters to communicate their dynamic appetites (discontinue an existing appetite, add to their appetite, change their appetite) nor is there an efficient way for brokers to discover the underwriters' current appetites for risk. Thus, what is needed is a secure searchable database of insurance companies' appetites for risk, and a search engine for brokers to quickly find which carriers will underwrite their prospective business customer.

As an exemplary embodiment, the invention may be used as a web application that provides a quick, secure, efficient and reliable way to match business insurance buyers (brokers) with sellers (insurance carrier) to create an efficient market, thereby replacing current paper-based systems or static digital systems. In some instances, proprietary web-based carrier systems may be displaced by the invention as well. For example, the invention may provide a searchable database that may serve as a unitary source of information for brokers to identify the current risk appetites of insurance underwriters (e.g., retailer and wholesaler, excess and surplus lines market and captive market). To ensure that the information is current, the database may be dynamically updatable by insurance carriers. That is, the invention allows for insurance carriers to update at will entries that set forth their own risk appetites. In turn, carriers are advantaged by the fact that the invention provides a means for attracting the type of risks they desire.

This inventive embodiment provides a novel and nonobvious improvement over prior art methods used to communicate carriers' appetites for risk for a number of reasons. First prior art methods do not allow for facile searching. In addition, prior art methods do not allow for at will or dynamic updating of carrier appetites.

The inventive embodiment exploits the fact that appetites or risks that insurance carriers are willing to underwrite for consumers are typically defined by three important attributes, i.e., line of coverage, state, and Standard Industry Classification (SIC) code. Insurance carriers (which include retail, wholesale, managing general agents, excess and surplus lines, captives, or any program business) may access the inventive system to indicate their desired risks (the business they want) by entering their appetite as the above-mentioned attributes via secure web access. The companies can at any time immediately adjust their attribute to reflect their changing appetite.

Brokers searching for a market specific to their needs may be prompted to enter the same attributes on simple on-line screens. In turn, the system may return a list of all carriers seeking this type of risk. Optionally, brokers and insurance carriers may use additional filters that further fine-tune the search results to meet their needs. For example, brokers may choose to have the results listed according to their priorities.

Additionally, the invention may allow for aggregation of data for supplier members, e.g., insurance carriers to help them identify profitable growth opportunities. For example, data may indicate that a large number of brokers are searching for carriers who underwrite biotech companies for liability. This would be an opportunity for an insurance carrier to develop a program specific for this.

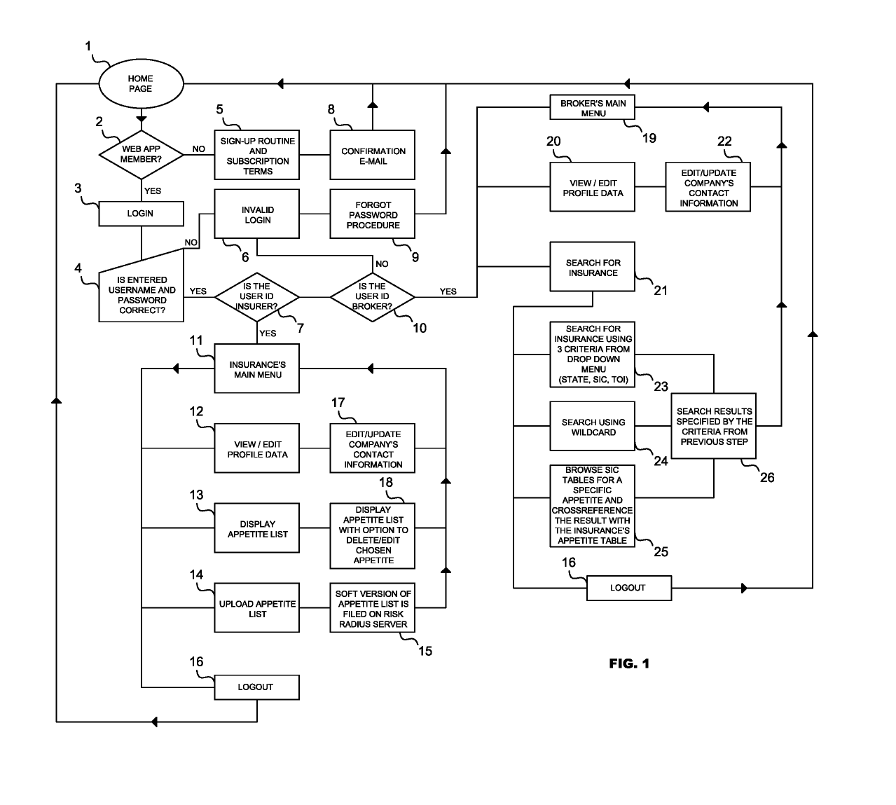

FIG. 1 provides a flow chart depicting the workings of an exemplary embodiment of the invention named RiskRadius. The following sets forth the various features of the flow chart.

Step 1: A home page is provided where a user is directed when linking onto the RiskRadius website address.

Step 2: A potential web application (WebApp) is provided where the user may choose to sign up for the service, in which case step 5 is carried out, or log in as a registered user, in which case step 3 is performed.

Step 3: The user enters his/her/its username and password in order to log in.

Step 4: If WebApp recognizes the username and password, step 7 is carried out. Otherwise, step 6 is carried out.

Step 5: The user is not a RiskRadius member and is prompted to fill out the contact information, choose username and ‘strong’ password, and agree to terms of use. Once the user does as prompted, step 8 is performed.

Step 6: When the username and/or password are invalid, an error page is displayed and step 9 is carried out.

Step 7: System determines whether the username is associated with an insurance carrier. If true, step 11 is carried out. Otherwise, step 10 is performed.

Step 8: Systems sends a confirmation email setting for the username and password to the email address entered as contact information.

Step 9: User is given a chance to retrieve his/her/its password via e-mail and/or to proceed to step 1.

Step 10: System verifies whether the username is associated with a broker. If true, step 19 is carried out; otherwise step 6 is performed.

Step 11: System displays the insurance carrier main menu by allowing the user to select any one of steps 12, 13, 14 and 16 for the system to carry out.

Step 12: System displays the user's profile information with an option to edit/update associated information in step 17.

Step 13: The user can scan through and display their appetite list, with option to filter/search information by any field.

Step 14: The user may have an option to upload its appetite list to the server in any computer file format.

Step 15: Uploaded file is stored in the user's secure personal folder on the server and either step 14 or 11 is performed.

Step 16: During log out, system resets all the user's variables stored in the user's session and proceeds to step 1.

Step 17: System allows user to change information displayed in step 12 and save changes on the server.

Step 18: System displays user's appetite list comprising a plurality of subappetites. The subappetites are listed and displayed with the following fields of information: type of insurance (TOI, also known as “line of insurance,” “business,” and “line of coverage”), SIC (Standard Industry Classification) code, state, and desirability code (gradation of desirability from best “5” to least “1”). The user may edit or delete information and save changes.

Step 19: When the user logs on with a broker's username, the broker main menu screen is displayed, which allows the user to have the system to carry any one of steps 20, 21 and 16.

Step 20: System displays the user's profile information with option to edit/update information in step 22.

Step 21: System displays three different ways to search for matches with the insurance carrier appetites. Each type of search is described in steps 23, 24, and 25.

Step 22: User edits contact information. System allows user to change any information displayed in step 20 and save changes on the server.

Step 23: User may select at least 2 out of 3 or all the attribute/filters, i.e., TOI (Line of Insurance), SIC Code, State using a drop down menu and/or text field to start the search for matches. Step 26 is carried out to match results.

Step 24: User may use a descriptive word (wildcard), in place of an SIC code, in the “Search by Description” field. Go to step 26 for match results.

Step 25: User may browse the SIC Codes table to find the SIC Code they are looking for. The user selects the desired SIC Code. The user also selects the TOI (Type of Insurance) and State to start a search. Step 26 is performed to match results.

Step 26: Search Results page displays the matches. These are the matches based on the broker user's attributes.

This embodiment of the invention may be provided as an application on a Software as a Service (SaaS) Platform. The SaaS platform allows for management of underlying computer hardware and software resources and uses those resources to endow its hosted applications with multi-tenant, on-demand capabilities that are found in SaaS applications. Generally, hosted applications are written to target the platform and support a single user. The platform absorbs the responsibility of distributing the application as a service to multiple users over the Internet. The SaaS platform may be used to reduce the time and difficulty associated with developing highly available, enterprise grade business applications that are to be delivered on-demand.

This embodiment of the invention may be provided to service customers via the internet. By eliminating the need to install and run the application on the customer's own computer, SaaS alleviates the customer's burden of software maintenance, ongoing operation, and support.

The key characteristics of SaaS platform, according to the International Data Corporation (IDC), include: network-based access to, and management of, commercially available software; activities that are managed from central locations rather than at each customer's site, enabling customers to access applications remotely via the Web; application delivery that typically is closer to a one-to-many model (single instance, multi-tenant architecture) than to a one-to-one model, including architecture, pricing, partnering, and management characteristics; and centralized feature updating, which obviates the need for downloadable patches and upgrades.

Much like any other software, SaaS can also take advantage of Service oriented architecture to enable software applications to communicate with each other. Each software service can act as a Service provider, exposing its functionality to other applications via public brokers, and can also act as a Service requester, incorporating data and functionality from other services.

RiskRadius is based on a SaaS Platform that uses a Database Management System (DBMS). DBMS is software that defines a database, stores the data, supports a query language, produces reports, and creates data entry screens. The role of a DBMS in a larger system is to allow other software, or users, to store and retrieve data in a structured way.

Specifically, Structured Query Language (SQL) may be used to support the DBMS. SQL is a database computer language designed for the retrieval and management of data in relational database management systems (RDBMS), database schema creation and modification, and database object access control management. SQL is a standard interactive and programming language for querying and modifying data and managing databases. Although SQL is both an ANSI and an ISO standard, the RiskRadius database supports SQL with extensions thereto. The core of SQL is formed by a command language that allows the retrieval, insertion, updating, and deletion of data, and performing management and administrative functions.

There are a number of nonobvious aspects of RiskRadius in view of the commercial insurance industry as a whole. For example, the commercial insurance industry comprises different sectors. The property and casualty sector includes coverage for property, liability, workers' compensation, errors & commissions, etc., and coverage period for the property and casualty sector is dictated by individual consumer desire and/or needs as they come up. Such desires and needs may change according to any of a number of factors. For example, purchasers of boat insurance may need to change their policy depending on when they buy or sell their boats, where they dock or sail their boats, and when they put their boats in and out of water. Thus, their insurance coverage needs may change quickly. Likewise, appetites for the property and casualty sectors may change due to their underwriters' financial capabilities at any particular time. For example, after a large payout due to a tsunami event, insurers may decide to mitigate their risk by withdrawing completely from further insuring boats where the event has taken place.

In contrast, the health benefits sector is typically purchased directly by employers for their employees' health insurance. Health care insurance purchasing decisions are typically made during a governmentally dictated annual open enrollment period, so supplier appetites do not change except on an annual basis. Thus, appetites of health care insurance underwriters do not generally change as quickly as the appetites of property and casualty insurance underwriters. The healthcare needs of a group of people as a whole do not change as unpredictably as their needs for property and casual insurance.

In addition, healthcare insurance property and casualty insurance are governed under different laws. For example, in some jurisdictions, healthcare insurance cannot legally be denied an individual for a pre-existing condition. In contrast, no comparable legal protection is known to be provided to those seeking property and/or casualty insurance. For example, there is no law requiring an insurance underwriter to provide fire insurance for a property owned by an individual convicted for arson and/or insurance fraud.

Thus, in many ways, the health care insurance and property and casualty insurance sectors operate according to different economic principles, and are thus not considered analogous in nature. That is, the level of complexity for the health benefits sector is neither analogous nor comparable to the complexity for property and casualty sector.

RiskRadius is designed primarily to serve the property and casualty sector. In this sector there are 3500 retail insurance companies and hundreds of wholesalers. There are at least 85 different products in the property and casualty sector. Such products include, for example: Abuse Coverage; Accident Insurance; Aircraft and Hull Liability; Aircraft Products Liability; Automobile Excess Liability Policy; Aviation Liability; Boiler and Machinery Insurance; Builders Risk; Building and Personal Property Coverage Form; Bumbleshoot Liability Insurance—Marine Exposure; Business Income Coverage; Cargo Insurance; Commercial General Liability; Commercial Package; Commercial Auto; Contingent and Excess; Contractors Equipment; Crime; Directors & Officers; Directors & Officers Side A; Difference in Conditions; Earthquake Insurance; Educator Liability; Electronic Data Processing Policy; Employed Lawyers Liability; Employee Dishonesty; Employment Practices Liability; Environmental Liability; Errors and Omissions—Technology; Errors and Omissions Insurance—General; Event Insurance; Excess; Excess Umbrella; Excess Workers Compensation; Fiduciary Bonds; Fiduciary Liability Insurance; Fine Arts Coverage; Flood Insurance; Foreign Insurance Requirements; Foreign Operations Insurance; Forensic Liability; Garage Liability; Growing Crop Insurance; Healthcare Facilities (Hospitals); Inland Marine Insurance; Installation Floater; Insurance Agents/Brokers, Errors and Omissions Insurance; Kidnap/Ransom Extortion Coverage; Liquor Liability; Marine Liability; Medical Malpractice; Media Organizations Liability; Mobile Equipment Floater; Mortgage Bankers and Servicing Agents Errors and Omissions; Non Owned Aircraft Liability; Ocean Marine; Owners and Contractors Protective Liability—OCP; Political Risk; Products Liability; Products Recall Expense Insurance; Professional Liability; Publishers or Broadcasters Liability Policies; Surety Bonds; Trade Credit Insurance; Transportation floater; Trip Transit Floater; Umbrella; Underground Storage Tank Liability—UST; USL&H; Warehousemen's Legal Liability; Windstorm; Workers Compensation; Workers Compensation—Large Deductible; Wrap-up; Yacht Policy; Event Insurance; Excess Auto; Employee Benefits Liability; Foster Parent; Auto Physical Damage; Dental Malpractice; Veterinarian Malpractice; Association Professional Liability; and Workplace Violence.

In addition, the number of products continues to grow as new coverage is designed to meet new risks, e.g., drone insurance, terrorism insurance, network security insurance. Insurance companies define their appetite for risk by type of insurance, SIC (Standard Industry Code) and the state where the insured is located. Furthermore, underwriter appetite for risk is dynamic depending on their loss history by type of insurance, SIC and state. The large number of variables makes it impossible for any insurance agent to know at any time which carriers are interested in insuring their prospects or renewing clients. This lack of information does not allow for free enterprise to be efficient nor effective. Insurance companies decline between 65% and 87% of all business submitted to them because the business does not meet their appetite. Agents and brokers blanket the market with applications because they cannot determine the appetite for risk of the hundreds and thousands of insurance companies they work with times the 85 different products they sell.

Furthermore, experimental results confirm a long-felt need for a system like RiskRadius. Given the complexity of the current property and casualty sector, an experiment has been carried out with 276 commercial insurance agencies. The agencies used the system to query the appetite of 57 insurance companies. In a single year, 3671 potential matches were shown to agents. Without RiskRadius, this would translate to an enormous waste of time.

### Variations on the Invention

Variations of the present invention will be apparent to those of ordinary skill in the art in view of the disclosure contained herein. For example, while the invention has been generally described in the context of compilations containing appetites of insurance carriers, the invention is not limited to the insurance industry. In addition, there has been recent growth in web-based social networking services. Such services generally focus on building online communities of people who share interests and/or activities, or who are interested in exploring the interests and activities of others. Most social network services provide a variety of ways for users to interact, such as email and instant messaging services. Exemplary social networking services may be found at myspace.com and facebook.com. The invention may incorporate the functionalities of such social networking services as well. For example, the inventive systems may include more than one class of entries, e.g., entries that set forth information relating to intermediaries instead of supplier appetites. Access to different classes of entries may differ depending on membership rights.

Various features specifically tailored to embodiments of the invention for the insurance industry may be provided. For example, if a broker does not find any matches, the broker may run it up a flagpole. The underwriting companies can see, peruse, and review the flagpole for business opportunities they would not normally receive. Interested companies can pursue the opportunity by contacting the broker. Similarly, the invention may provide a database of insurance professionals searchable by expertise and location. For an example, if a broker or carrier is seeking an underwriter with expertise in bio-technology, they can search by expertise, location, geography. Furthermore, the invention may provide a listing of agents and carriers by specialties and geography that is open to consumers and the public. Still furthermore, the invention may incorporate a social network among the commercial property and casualty insurance community. Individuals, brokers, insurance carriers can create their own pages. Finally, a classified section may be provided (sorted by region, type of insurance, line of business) to list employment opportunities. Individuals can identify their own skill sets and interests.

In any case, it should be noted that any particular embodiment of the invention may be modified to include or exclude features of other embodiments as appropriate without departing from the spirit of the invention. It is also believed that principles such as “economies of scale” and “network effects” are applicable to the invention and that synergies arising from the invention's novelty and nonobviousness increase when the invention is practiced with increasing numbers of entries, supplier members, intermediary members, consumers and/or the like. In some instances, for example, the invention may be practiced with at least 50 entries and/or 50 different insurance underwriter members. Appropriate usage of computerized and/or communication means, e.g., web-based hardware and/or software, cellular and land-based telephonic equipment, and antenna-based, satellite and cable television technologies, allow for further synergies.

It is to be understood that, while the invention has been described in conjunction with the preferred specific embodiments thereof, the foregoing description merely illustrates and does not limit the scope of the invention. Numerous alternatives and equivalents exist which do not depart from the invention set forth above. Other aspects, advantages, and modifications within the scope of the invention will be apparent to those skilled in the art to which the invention pertains.

All patents and patent applications mentioned herein are hereby incorporated by reference in their entireties to the fullest extent not inconsistent with the description set forth above.

What is claimed is:

1. An electronic system for assisting members of an intermediary membership to match a consumer request with substantially current appetites of members of an insurance underwriter membership to provide insurance products that may satisfy the consumer request, comprising:
a compilation of electronic entries, each entry setting forth a substantially current appetite of a different insurance underwriter member, wherein
each entry has a unique identifier for its underwriter member,
each current appetite includes at least one subappetite,
each subappetite is at least partially classifiable by a first attribute selected from a first class of attributes and by a second attribute selected from a second class of attributes, and
the first and second classes of attributes share no common attribute with each other;
an electronic entry-updating means for allowing each insurance underwriter member to update its entry at will;
an electronic query means for allowing intermediary members to input a consumer request as a query that comprise first and second subqueries;
an electronic filtering means for determining whether any entry from the compilation matches the query, wherein any matching entry must include a subappetite having first and second attributes that match the first and second subqueries, respectively;
display means for displaying at least the unique identifier of any matching entry determined by the electronic filtering means; and
a membership rights means for providing different systemic rights for insurance underwriter members, intermediary members, and consumers.

2. The system of claim 1, wherein the compilation comprises at least 50 entries.

3. The system of claim 1, wherein the system is used by at least 50 different insurance underwriter members.

4. The system of claim 1, wherein the appetites are underwriting appetites for property and/or casualty insurance.

5. The system of claim 1, wherein the appetites exclude appetites for health insurance.

6. The system of claim 1, wherein each current appetite includes a plurality of subappetites.

7. The system of claim 1, wherein one of the first and second classes of attributes is a geography class.

8. The system of claim 1, wherein one of the first and second classes of attributes is an industry class.

9. The system of claim 1, wherein one of the first and second classes of attributes is an insurance descriptor class.

10. The system of claim 1, wherein each appetite is further classifiable by a third attribute selected from a third class of attributes.

11. The system of claim 10, wherein the third class of attributes share no common attribute with at least one of the first and second classes of attributes.

12. The system of claim 11, wherein the first, second, and third classes of attributes share no common attribute with both of the first and second classes of attributes.

13. The system of claim 1, wherein each subappetite is further classifiable by a desirability rating, and, when a plurality of matching entries are determined by the electronic filtering means, the electronic display means displays the unique identifiers of the matching entries in an order that is determined at least partially according to the desirability ratings of the subappetites of the matching entries.

15. The system of claim 1, wherein the membership rights means is effective to ensure that insurance underwriter and intermediary memberships are mutually exclusive relative to each other.

16. The system of claim 1, wherein the membership rights means prohibits insurance underwriter members from accessing the electronic query means.

17. The system of claim 1, wherein the membership rights means prohibits insurance underwriter members from accessing any entry for other members.

18. The system of claim 1, wherein the membership rights means prohibits intermediary members from accessing the electronic-updating means.

19. The system of claim 1, wherein the system is an internet-based system.

20. A web-based system for matching a consumer request with substantially current appetites of members of an insurance underwriting membership, comprising:
a compilation of electronic entries, wherein each entry is identified by a unique identifier and sets forth a substantially current appetite of a different underwriting member interested in underwriting a property and/or casualty policy,
an electronic entry-updating means for allowing each underwriting member to update its corresponding entry at will;
an electronic query means for allowing input of a consumer request as a query;
an electronic filtering means for determining whether determining whether any entry from the compilation matches the query; and
a display means for displaying at least the unique identifier of any entry determined by the electronic filtering means as a matching entry.
